(19) United States
(12) Patent Application Publication
(10) Pub. No.: US 2018/0147627 A1
(43) Pub. Date: May 31, 2018

(54) POWDER FOR ENERGY BEAM SINTERING, METHOD FOR PRODUCING POWDER FOR ENERGY BEAM SINTERING, AND METHOD FOR PRODUCING SINTERED BODY

(71) Applicant: Seiko Epson Corporation, Tokyo (JP)

(72) Inventors: Hidefumi NAKAMURA, Hachinohe (JP); Toshiki AKAZAWA, Hachinohe (JP)

(21) Appl. No.: 15/817,751

(22) Filed: Nov. 20, 2017

(30) Foreign Application Priority Data
Nov. 30, 2016 (JP) 2016-233056

(51) Int. Cl. B22F 1/00; B23K 15/00; B33Y 70/00

(52) U.S. Cl. CPC B22F 1/0062; B23K 15/0086; B22F 1/0011; B33Y 10/00; B22F 2302/45; B22F 2304/10; B33Y 70/00

(57) ABSTRACT

A powder for energy beam sintering includes a plurality of metal particles and a binder which binds the metal particles to one another, wherein the ratio of the bulk density to the true density of the metal particles is 30.5% or more and 45% or less, and the flow rate is 15 sec/50 g or more and 28 sec/50 g or less. The main component of the metal particles is preferably any of iron, nickel, and cobalt. The binder preferably contains polyvinyl alcohol or polyvinylpyrrolidone.

### BACKGROUND

### 1. Technical Field

The present invention relates to a powder for energy beam sintering, a method for producing a powder for energy beam sintering, and a method for producing a sintered body.

### 2. Related Art

Stereolithography in which a structure is produced by irradiating a metal powder with a laser light is becoming widespread. This method is suitable for the production of many kinds in small quantities because a structure is formed by controlling a laser light using a computer.

Such a production method is disclosed in, for example, JP-T-2001-504897 (Patent Document 1). In the production method described in Patent Document 1, first, a metal powder is spread out on a flat plate, whereby a metal powder layer is formed. Subsequently, a leveling plate is moved along the surface of the metal powder layer, whereby the surface is leveled and the thickness thereof is adjusted to a predetermined thickness. Subsequently, a protective gas is allowed to flow on the metal powder layer, whereby a protective gas atmosphere is formed. Subsequently, a laser light is formed into a beam and scanned, whereby a predetermined image is drawn. In a place irradiated with the laser light, the metal powder is sintered and bound.

Thereafter, a step of spreading out the metal powder, a step of leveling the metal powder, and a step of irradiating the metal powder with the laser light are repeated. By doing this, a structure having a three-dimensional shape is formed by binding the metal powder sintered in the respective layers.

Further, JP-A-2015-105201 (Patent Document 2) discloses a method in which a powder layer is formed using a granulated material obtained by spray drying granulation, and thereafter, a sintered layer is formed by irradiation with a laser light, whereby a stacked body is produced. By using such a granulated material, the fluidity of the raw material becomes favorable, so that a powder layer is easily formed.

However, when the metal powder is sintered by irradiating the metal powder layer with a laser, the volume of the metal powder layer shrinks. Due to this, a difference in the thickness of the metal powder layer occurs between a region where the metal powder is sintered and a region where the metal powder is not sintered. In particular, when the granulated powder is used, the shrinkage ratio tends to increase, and therefore, this difference in the thickness of the metal powder layer is likely to increase.

By increasing such a difference in the thickness, it is necessary to increase the thickness of the metal powder to be spread out thereon. That is, when the region where the metal powder is sintered largely shrinks, a large level difference occurs between the region where the metal powder is sintered and the region where the metal powder is not sintered, and therefore, as a result of spreading out the metal powder thereon, a metal powder layer which is relatively thick is formed on the region where the metal powder is not sintered.

In the thick metal powder layer formed in this manner, there is a fear that the entire metal powder in the thickness direction is not sintered when being irradiated with a laser. Due to this, in a part of the structure having a three-dimensional shape, sintering of the metal powder becomes incomplete, and therefore, there is a fear that the mechanical strength is deteriorated.

### SUMMARY

An advantage of some aspects of the invention is to provide a powder for energy beam sintering capable of producing a sintered body of high quality by irradiation with an energy beam, a method for efficiently producing the powder for energy beam sintering, and a method for producing a sintered body capable of producing a sintered body of high quality.

The advantage can be achieved by the following configurations.

A powder for energy beam sintering according to an aspect of the invention includes a plurality of metal particles, and a binder which binds the metal particles to one another, wherein the ratio of the bulk density to the true density of the metal particles is 30.5% or more and 45% or less, and the flow rate is 15 sec/50 g or more and 28 sec/50 g or less.

According to this configuration, a powder for energy beam sintering capable of producing a sintered body of high quality by irradiation with an energy beam is obtained.

In the powder for energy beam sintering according to the aspect of the invention, it is preferred that the main component of the metal particles is any of iron, nickel, and cobalt.

According to this configuration, a sintered body produced using the powder for energy beam sintering contains any of iron, an iron alloy, nickel, a nickel alloy, cobalt, and a cobalt alloy as a main material, and therefore has excellent mechanical properties.

In the powder for energy beam sintering according to the aspect of the invention, it is preferred that the binder contains polyvinyl alcohol or polyvinylpyrrolidone.

According to this configuration, the powder for energy beam sintering can be efficiently formed even if the amount of the binder is a relatively small amount, and therefore, the total amount of the binder can be reduced, so that the bulk density is easily increased. Further, the thermal decomposability thereof is also high, and therefore, the binder can be reliably decomposed and removed in a short time during degreasing and firing, and thus, the surface roughness and dimensional accuracy of a sintered body are easily enhanced.

In the powder for energy beam sintering according to the aspect of the invention, it is preferred that the average particle diameter of the metal particles is 2 μm or more and 20 μm or less.

According to this configuration, the surface roughness of a sintered body to be produced using the powder for energy beam sintering can be made particularly small, and a sintered body of high quality having high dimensional accuracy and high mechanical strength is obtained.

In the powder for energy beam sintering according to the aspect of the invention, it is preferred that a heated material of the binder is further included.

According to this configuration, the densification of the powder for energy beam sintering is further enhanced, and therefore, a sintered body of higher quality can be produced.

A method for producing a powder for energy beam sintering according to an aspect of the invention includes obtaining temporary particles by binding metal particles to one another using a binder solution containing a binder, and heating the temporary particles.

According to this configuration, the powder for energy beam sintering according to the aspect of the invention can be efficiently produced.

A method for producing a sintered body according to an aspect of the invention includes forming a powder layer containing the powder for energy beam sintering according to the aspect of the invention and sintering the metal particles by irradiating the powder layer with an energy beam.

According to this configuration, a sintered body of high quality can be efficiently produced.

### BRIEF DESCRIPTION OF THE DRAWINGS

The invention will be described with reference to the accompanying drawings, wherein like numbers reference like elements.

FIG. 1 is a perspective view schematically showing an embodiment of a powder for energy beam sintering according to the invention.

FIG. 2 is a schematic view for illustrating a state where the powder for energy beam sintering according to the embodiment is sintered.

FIG. 3 is a schematic view for illustrating a state where the powder for energy beam sintering according to the embodiment is sintered.

FIG. 4 is a schematic view for illustrating a state where the powder for energy beam sintering according to the embodiment is sintered.

FIG. 5 is a schematic view for illustrating a state where the powder for energy beam sintering according to the embodiment is sintered.

FIG. 6 is a schematic view for illustrating a state where the powder for energy beam sintering according to the embodiment is sintered.

FIG. 7 is a schematic view showing a structure of a spray drying device for producing the powder for energy beam sintering according to the embodiment.

FIG. 8 is a schematic view showing a structure of a laser sintering device for producing a sintered body using the powder for energy beam sintering.

FIG. 9 is a schematic view for illustrating a method for forming a structure using the powder for energy beam sintering (an embodiment of a method for producing a sintered body according to the invention).

FIG. 10 is a schematic view for illustrating the method for forming a structure using the powder for energy beam sintering (the embodiment of the method for producing a sintered body according to the invention).

FIG. 11 is a schematic view for illustrating the method for forming a structure using the powder for energy beam sintering (the embodiment of the method for producing a sintered body according to the invention).

FIG. 12 is a schematic view for illustrating the method for forming a structure using the powder for energy beam sintering (the embodiment of the method for producing a sintered body according to the invention).

FIG. 13 is a schematic view for illustrating the method for forming a structure using the powder for energy beam sintering (the embodiment of the method for producing a sintered body according to the invention).

FIG. 14 is a schematic view for illustrating the method for forming a structure using the powder for energy beam sintering (the embodiment of the method for producing a sintered body according to the invention).

FIG. 15 is a schematic view for illustrating the method for forming a structure using the powder for energy beam sintering (the embodiment of the method for producing a sintered body according to the invention).

FIG. 16 is a schematic view for illustrating the method for forming a structure using the powder for energy beam sintering (the embodiment of the method for producing a sintered body according to the invention).

FIG. 17 is a schematic view for illustrating the method for forming a structure using the powder for energy beam sintering (the embodiment of the method for producing a sintered body according to the invention).

FIG. 18 is a schematic view for illustrating the method for forming a structure using the powder for energy beam sintering (the embodiment of the method for producing a sintered body according to the invention).

### DESCRIPTION OF EXEMPLARY EMBODIMENTS

Hereinafter, a powder for energy beam sintering, a method for producing a powder for energy beam sintering, and a method for producing a sintered body according to the invention will be described in detail based on preferred embodiments shown in the accompanying drawings.

### Powder for Energy Beam Sintering

First, an embodiment of a powder for energy beam sintering according to the invention will be described.

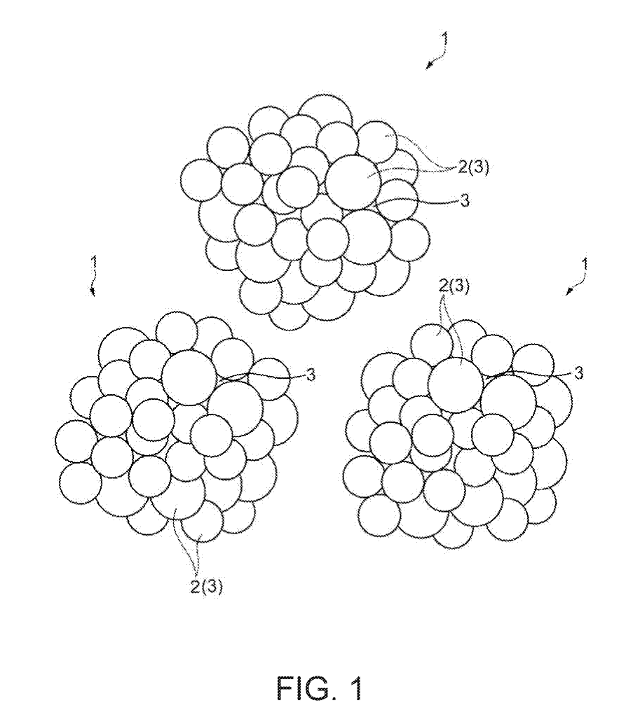

FIG. 1 is a perspective view schematically showing an embodiment of a powder for energy beam sintering according to the invention.

The powder for energy beam sintering shown in FIG. 1 includes a plurality of (three as an example) granulated particles 1. Each of the granulated particles 1 includes a plurality of metal particles 2, and the metal particles 2 are collected in the form of a particle as a whole by interposing a binder 3 between the metal particles 2.

That is, the granulated particle 1 includes the plurality of metal particles 2 and the binder 3 which binds the metal particles 2 to one another.

The granulated particle 1 has a characteristic that the ratio of the bulk density (the bulk density of the granulated particles 1) to the true density of the metal particles 2 is 30.5% or more and 45% or less, and the flow rate is 15 sec/50 g or more and 28 sec/50 g or less.

The powder for energy beam sintering including such granulated particles 1 has a relatively large ratio of the bulk density to the true density of the metal particles 2, and also has a relatively high flow rate. Due to this, in a powder layer formed using such a powder for energy beam sintering, the proportion of gaps or the binder causing shrinkage during sintering is kept sufficiently low. Therefore, when such a powder layer is irradiated with an energy beam such as a laser to effect sintering, a level difference occurring between a region where the powder is sintered and a region where the powder is not sintered can be minimized. As a result, it is no longer necessary to increase the thickness of the granulated particles 1 to be spread out so as to fill the level difference more than necessary, and the problem that sintering becomes incomplete can be solved.

As described above, sintering by an energy beam can be stably performed, and therefore, a sintered body of high quality having favorable surface roughness and high mechanical strength is obtained. Further, by performing drawing using an energy beam, a sintered body having a desired shape can be produced with high dimensional accuracy.

The ratio of the bulk density to the true density of the metal particles 2 (hereinafter abbreviated as “bulk density ratio”) is set to 30.5% or more and 45% or less, but is set to preferably 31% or more and 40% or less, more preferably 32% or more and 35% or less. If the bulk density ratio is lower than the above lower limit, when the powder layer is formed using the powder for energy beam sintering, the proportion of gaps or the binder causing shrinkage during sintering cannot be kept sufficiently low, and therefore, the shrinkage ratio cannot be kept low, and thus, the quality of the sintered body may be deteriorated. On the other hand, if the bulk density ratio exceeds the above upper limit, the shape retention property of the granulated particles 1 themselves is deteriorated, and it becomes difficult to maintain the spherical shape thereof. Due to this, the granulated particles 1 are likely to be chipped during flowing, and the packing ratio of the granulated particles 1 in the powder layer is decreased, and therefore, the shrinkage ratio cannot be kept low. Therefore, the quality of the sintered body may be deteriorated.

The bulk density of the powder for energy beam sintering (granulated particles 1) is measured in accordance with the test method for apparent density of metal powders specified in JIS Z 2504:2012.

The true density of the metal particles 2 is calculated based on the elements constituting the metal particles 2 and the compositional ratio thereof.

The flow rate of the powder for energy beam sintering is set to 15 sec/50 g or more and 28 sec/50 g or less, but is set to preferably 18 sec/50 g or more and 25 sec/50 g or less, more preferably 20 sec/50 g or more and 24 sec/50 g or less. If the flow rate exceeds the above upper limit, when the powder layer is formed using the powder for energy beam sintering, the packing property of the granulated particles 1 in the powder layer cannot be sufficiently enhanced. Due to this, the porosity in the powder layer eventually increases to increase the shrinkage ratio of the powder layer during sintering, and therefore, there is a fear that the quality of the sintered body is deteriorated. On the other hand, if the flow rate is lower than the above lower limit, when the powder layer is formed using the powder for energy beam sintering, a friction force between the granulated particles 1 necessary for maintaining the powder layer is decreased. Due to this, when vibration, wind, or the like is applied to the powder layer, the surface of the powder layer is disturbed, and therefore, there is a fear that the quality of the sintered body is deteriorated.

The flow rate of the powder for energy beam sintering (granulated particles 1) is measured in accordance with the test method for flow rate of metal powders specified in JIS Z 2502:2012.

The average particle diameter (the particle diameter at a cumulative percentage of 50% in a cumulative particle size distribution on a mass basis) of the metal particles 2 is not particularly limited, but is preferably 2 μm or more and 20 μm or less, more preferably 5 μm or more and 10 μm or less. By using the metal particles 2 having such a relatively small particle diameter, the surface roughness of a sintered body to be produced can be made particularly small. Further, miniaturization of the crystal structure in the sintered body can be achieved, and therefore, the mechanical strength of the sintered body can be increased. As a result, a sintered body of high quality having high dimensional accuracy and high mechanical strength is obtained.

When the average particle diameter of the metal particles 2 is lower than the above lower limit, depending on the constituent material of the metal particles 2, the metal particles 2 are likely to drift in the air, and therefore, there is a fear that it becomes difficult to handle the metal particles 2. Further, when the average particle diameter of the metal particles 2 exceeds the above upper limit, depending on the constituent material of the metal particles 2, the sinterability of the metal particles 2 is deteriorated, and therefore, there is a fear that it takes a long time to produce the sintered body.

The average particle diameter of the metal particles 2 is a particle diameter when the cumulative percentage on a mass basis from the small diameter side in a particle size distribution obtained by laser diffractometry is 50%.

The constituent material of the metal particles 2 is not particularly limited as long as it is a metal material, however, preferably, a material containing any of iron, nickel, and cobalt as a main component is used. That is, the main component of the metal particles 2 is preferably any of iron, nickel, and cobalt. According to this, the sintered body produced using the powder for energy beam sintering contains any of iron, an iron alloy, nickel, a nickel alloy, cobalt, and a cobalt alloy as a main material, and therefore has excellent mechanical properties.

When the constituent material of the metal particles 2 is a material containing iron as a main component, the constituent material of the metal particles 2 preferably further contains any one element or a plurality of elements selected from nickel, chromium, molybdenum, and carbon.

When the constituent material of the metal particles 2 is a material containing nickel as a main component, the constituent material of the metal particles 2 preferably further contains any one element or a plurality of elements selected from chromium, molybdenum, and carbon.

According to this, the sintered body produced using the powder for energy beam sintering has more excellent corrosion resistance or mechanical properties.

The “main component” as used herein refers to an element whose content ratio on a mass basis is the highest among the elements contained.

The metal particles 2 may be produced by any production method, however, preferably, metal particles produced by an atomization method are used. Examples of the atomization method include a water atomization method, a gas atomization method, and a spinning water atomization method, and any method may be used.

The shape of the metal particle 2 is not particularly limited, and may be a spherical shape such as a true sphere or an elliptical sphere, a polyhedral shape such as a cube or a rectangular parallelepiped, a columnar shape such as a cylinder or a prism, or a conical shape such as a cone or a pyramid, or may be another irregular shape.

When the minor axis of the metal particle 2 is represented by S (μm) and the major axis thereof is represented by L (μm), the average of the aspect ratio defined by S/L is preferably 0.3 or more and 0.9 or less, more preferably 0.4 or more and 0.8 or less. The metal particle 2 having such an aspect ratio has a shape with a given anisotropy. Due to this, when the metal particles 2 are bound to one another through the binder 3, the granulated particles 1 are likely to be caught on one another. Therefore, when the powder for energy beam sintering is molded, the property of maintaining the state of adhering the granulated particles 1 to one another is easily exhibited. Then, when a powder layer is formed using the powder for energy beam sintering, and thereafter compressed in the thickness direction, a given frictional resistance can be ensured between the metal particles 2. Due to this, the compressed powder layer can be prevented from collapsing at once. As a result, it contributes to ensuring the shape retention property of the powder layer after being compressed.

The “major axis” is the maximum possible length in the projected image of the metal particle 2, and the “minor axis” is the maximum possible length in the direction perpendicular to the maximum possible length. The average of the aspect ratio can be obtained as the average of the values of the measured aspect ratios of 100 or more metal particles 2.

Further, from the viewpoint of frictional resistance between the metal particles 2, as the atomization method when producing the metal particles 2, a water atomization method or a spinning water atomization method using a liquid as a medium for atomizing a molten metal is more preferably used. In any of these atomization methods, water is used as the medium for atomizing a molten metal, and therefore, the collision energy when atomizing a molten metal is high, and also the cooling rate for cooling the atomized molten metal is also high. Due to this, small irregularities are likely to be formed on the surfaces of the metal particles 2 to be produced as compared with a method in which a gas is used as a medium for atomizing a molten metal such as a gas atomization method, and in this point, the frictional resistance between the metal particles 2 can be relatively increased.

The surfaces of the metal particles 2 are covered with the binder 3. Further, the binder 3 is also present in a gap between the metal particles 2. In this manner, the granulated particles 1 are configured such that the metal particles 2 are bound to one another by the binder 3.

The constituent material of the binder 3 is not particularly limited as long as it is a material which is likely to be vaporized by sublimation or decomposition through heating, however, examples thereof include various resins including polyolefins such as polyethylene, polypropylene, and ethylene-vinyl acetate copolymers, acrylic resins such as polymethyl methacrylate and polybutyl methacrylate, styrenic resins such as polystyrene, polyesters such as polyvinyl chloride, polyvinylidene chloride, polyamide, polyethylene terephthalate, and polybutylene terephthalate, polyether, polyvinyl alcohol, polyvinylpyrrolidone, and copolymers and the like thereof, waxes, alcohols, higher fatty acids, fatty acid metal salts, higher fatty acid esters, higher fatty acid amides, nonionic surfactants, and silicone-based lubricants. Among these, one type or a mixture of two or more types is used.

It is preferred that the binder 3 contains a water-soluble resin such as polyvinyl alcohol (PVA) or polyvinylpyrrolidone (PVP) among these. These materials have a high binding property, and therefore can efficiently form the granulated particles 1 even if the amount of the binder 3 is a relatively small amount. Due to this, the total amount of the binder 3 can be reduced, so that the bulk density is easily increased. Further, the thermal decomposability thereof is also high, and therefore, the binder 3 can be reliably decomposed and removed in a short time during degreasing and firing. Therefore, it has an advantage that the surface roughness and dimensional accuracy of a sintered body are easily enhanced.

The amount of the binder 3 is appropriately adjusted according to the type of the metal particles 2 or the like, but is set to, for example, 0.1 parts by mass or more and 5.0 parts by mass or less with respect to 100 parts by mass of the metal particles 2.

In the binder 3, other than the material which is likely to be vaporized by sublimation or decomposition through heating, a material which is not vaporized may be contained as long as the amount thereof is a small amount so that the sintering of the metal particles 2 is not inhibited. In this case, the amount of the material which is not vaporized is preferably 10 mass % or less, more preferably 5 mass % or less with respect to the amount of the binder 3.

Further, in the binder 3, a plurality of types of materials which are likely to be vaporized by sublimation or decomposition through heating and have sublimation temperatures or decomposition temperatures different from one another may be contained. By containing such a plurality of types of materials, when the binder 3 is heated, the plurality of types of materials are sequentially sublimated or decomposed with a certain time difference. Due to this, in the process of heating the binder 3, the time period during which the binder 3 exists without vaporizing can be secured longer, and therefore, the time period during which the metal particles 2 are bound to one another can be secured longer by that amount. As a result, when a powder layer is formed using the powder for energy beam sintering as described later, the shape retention property thereof can be further enhanced, and the dimensional accuracy of a sintered body to be produced in the end can be further enhanced.

For example, in the case where two types of materials whose sublimation temperatures or decomposition temperatures are different from one another are contained in the binder 3, a difference in sublimation temperature or decomposition temperature is preferably 3° C. or more and 100° C. or less, more preferably 5° C. or more and 70° C. or less. By setting the difference in sublimation temperature or decomposition temperature within the above range, the shape retention property of the powder layer can be sufficiently enhanced, and therefore, the dimensional accuracy of a sintered body to be obtained in the end can be further enhanced.

The average particle diameter (the particle diameter at a cumulative percentage of 50% in a cumulative particle size distribution on a mass basis) of the granulated particles 1 is not particularly limited, but is preferably 20 μm or more and 100 μm or less, more preferably 30 μm or more and 60 μm or less. When the average particle diameter of the granulated particles 1 is less than the above lower limit, depending on the constituent material of the metal particles 2, the granulated particles 1 are likely to be stirred up when being irradiated with an energy beam, and therefore, it becomes difficult to form a sintered body. On the other hand, when the average particle diameter of the granulated particles 1 exceeds the above upper limit, the size of spaces between the granulated particles 1 is increased, and therefore, there is a fear that air bubbles are formed in the produced sintered body depending on the shape of the granulated particles 1 or the like.

The average particle diameter of the granulated particles 1 is a particle diameter when the cumulative percentage on a mass basis from the small diameter side in a particle size distribution obtained by laser diffractometry is 50%.

On the other hand, the average particle diameter of the granulated particles 1 is preferably 3 times or more and 10 times or less the average particle diameter of the metal particles 2. By setting the average particle diameter of the granulated particles 1 within the above range, the balance of the particle diameter between the granulated particles 1 and the metal particles 2 is optimized, and therefore, both the fluidity of the granulated particles 1 and the sinterability of the metal particles 2 can be achieved. Further, when a powder layer formed using the granulated particles 1 is compressed in the thickness direction, the granulated particles 1 become moderately easy to collapse, and also the metal particles 2 are easily rearranged more densely, and thus, the volume shrinkage when sintering the metal particles 2 can be further reduced.

### Behavior During Sintering of Powder for Energy Beam Sintering

Next, the behavior during sintering of the powder for energy beam sintering according to this embodiment will be described.

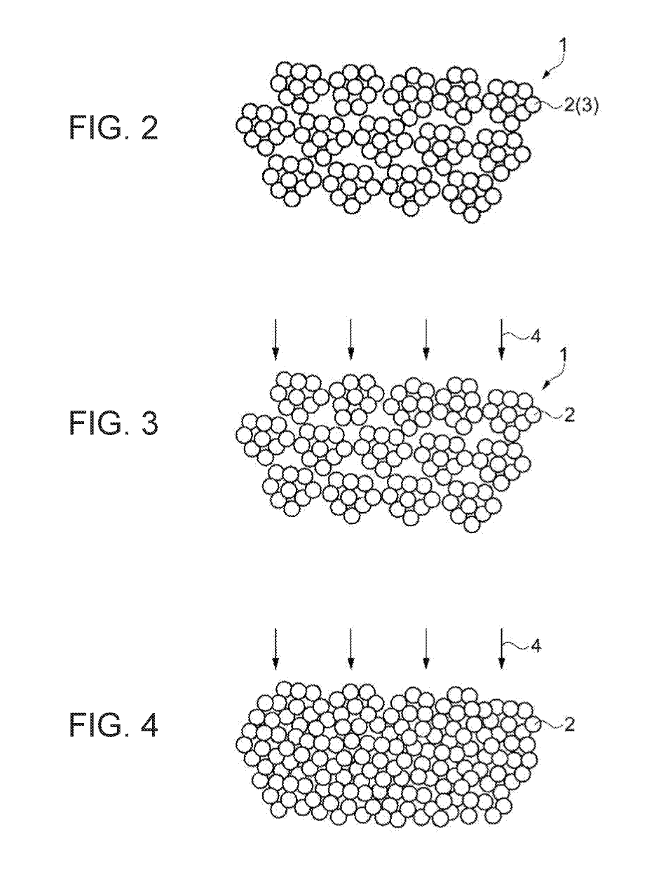

FIGS. 2 to 6 are each a schematic view for illustrating a state where the powder for energy beam sintering according to the embodiment is sintered.

In FIGS. 1 to 3, for convenience of explanation, the plurality of granulated particles 1 are shown separately from one another. When using the powder for energy beam sintering, a large number of granulated particles 1 are spread out in an overlapped manner to form a powder layer.

That is, as shown in FIG. 2, first, a powder layer is formed by spreading out a large number of granulated particles 1 in an overlapped manner. In FIG. 2, three layers, each of which is composed of a large number of granulated particles 1, are overlapped to form the powder layer, however, the number of layers of the granulated particles 1 to be stacked is not particularly limited. However, from the viewpoint of controlling the arrangement of the metal particles 2 after sintering, the granulated particles 1 to be spread out by one operation are preferably spread out in one layer.

Subsequently, as shown in FIG. 3, the powder layer is irradiated with a laser 4 (energy beam). By the laser 4, the binder 3 is heated and vaporized. Due to this, the binding force between the metal particles 2 by the binder 3 is decreased so that the metal particles 2 become easy to move. As a result, as shown in FIG. 4, by heating the metal particles 2, the fluidity of the metal particles 2 is further increased. Then, the metal particles 2 move also to gaps between the granulated particles 1.

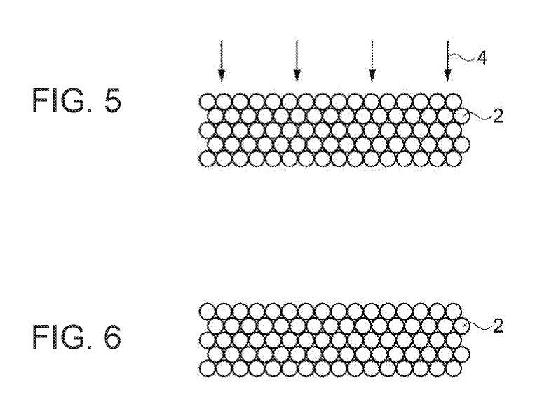

In this manner, as shown in FIG. 5, the metal particles 2 are arranged in lines. Then, the heated metal particles 2 are brought into a state where the adjacent metal particles 2 come closer to one another, resulting in sintering. That is, a metal bond is formed between the metal particles 2. When the irradiation with the laser 4 is stopped, the metal particles 2 in lines are cooled. At this time, a metal bond is formed between the metal particles 2, and therefore, a metal sintered body in the form of a block corresponding to a region irradiated with the laser 4 is formed. As a result, in the formed sintered body, the metal particles 2 are densely arranged as shown in FIG. 6, and therefore, a sintered body having glossy surfaces, for example, not only on the upper and lower sides in FIG. 6, but also on the left and right sides in FIG. 6 (side surfaces) can be obtained.

### Method for Producing Powder for Energy Beam Sintering

Next, an embodiment of a method for producing a powder for energy beam sintering according to the invention will be described.

The method for producing a powder for energy beam sintering according to this embodiment includes a step of obtaining temporary particles by binding metal particles 2 to one another using a binder solution containing a binder 3, and a step of heating the temporary particles. According to this method, the powder for energy beam sintering can be efficiently produced.

Hereinafter, the respective steps will be sequentially described.

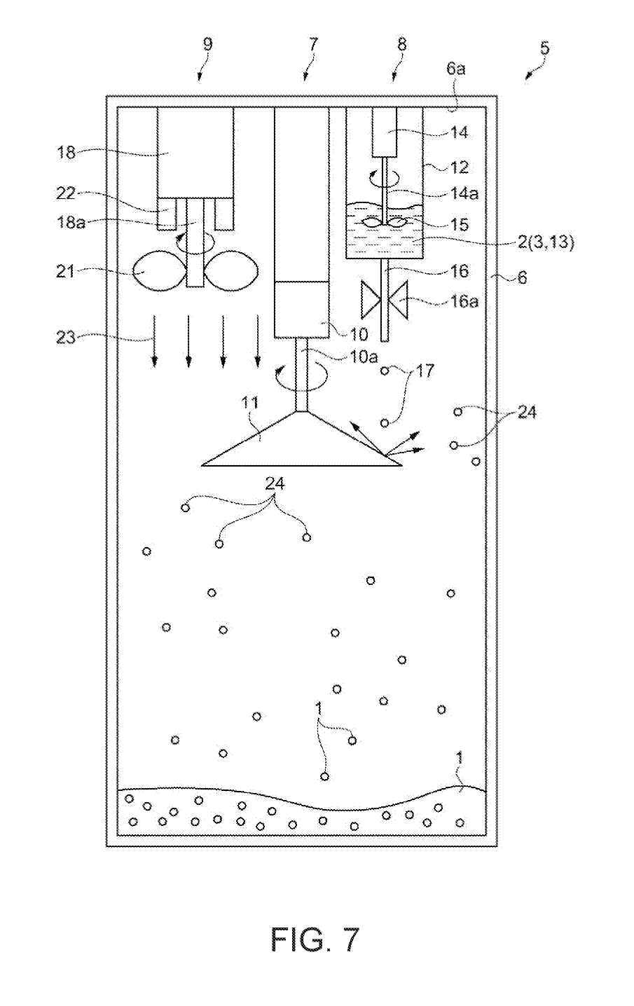

First, FIG. 7 is a schematic view showing a structure of a spray drying device for producing the powder for energy beam sintering according to this embodiment. As shown in FIG. 7, a spray drying device 5 includes a first vessel 6. On a ceiling 6a of the first vessel 6, a disk rotor 7, a starting material dropping unit 8, and a hot air blower 9 are provided. The disk rotor 7 includes a motor 10, and a conical rotary plate 11 is attached to a rotating shaft 10a of the motor 10. The rotary plate 11 is rotated by the motor 10.

The starting material dropping unit 8 includes a second vessel 12. In the second vessel 12, metal particles 2, a binder 3, and a solvent 13 for dissolving the binder 3 are placed. The solvent 13 may be any as long as it is a medium which dissolves the binder 3, has a low viscosity, and is readily dried, and the composition thereof is not particularly limited. As the solvent 13, for example, water, methyl alcohol, ethyl alcohol, MEK (methyl ethyl ketone), or the like can be used. In the case where a water-soluble resin such as polyvinyl alcohol or polyvinylpyrrolidone as described above is used as the binder 3, water can be used as the solvent 13. According to this, for example, an environmental load can be reduced.

In the second vessel 12 of the starting material dropping unit 8, a motor 14 is provided on the side of the ceiling 6a, and an impeller 15 is attached to a rotating shaft 14a of the motor 14. The impeller 15 is rotated by the motor 14. The impeller 15 has a function of stirring the metal particles 2, the binder 3, and the solvent 13. By performing stirring using the impeller 15, the metal particles 2 are uniformly dispersed and the binder 3 is uniformly dissolved in the solvent 13.

An ejection port 16 is disposed on the lower side of the second vessel 12 shown in FIG. 7. From the ejection port 16, liquid droplets 17 of a slurry composed of the metal particles 2 and the binder solution (the binder 3 and the solvent 13) are dropped. The ejection port 16 is provided with a solenoid valve 16a, and by the solenoid valve 16a, the size of the liquid droplets 17 and the ejection frequency can be adjusted.

The hot air blower 9 includes a motor 18 provided on the side of the ceiling 6a. Further, an impeller 21 is attached to a rotating shaft 18a of the motor 18. The impeller 21 is rotated by the motor 18. A heater 22 is provided between the motor 18 and the impeller 21. The heater 22 heats an air stream flowing around the heater 22. According to this, the hot air blower 9 causes a hot air 23 to flow downward in FIG. 7.

The gravitational force acts on the liquid droplets 17 ejected from the ejection port 16. On the vertically lower side of the ejection port 16, the rotating rotary plate 11 is disposed. When the liquid droplet 17 hits the rotary plate 11, it breaks up into small liquid droplets 24. The small liquid droplets 24 fly in the air. Around the rotary plate 11, the hot air 23 flows, and therefore, the solvent 13 in the small liquid droplets 24 is heated by the hot air 23 and thus vaporized. By doing this, the small liquid droplets 24 are dried, and the metal particles 2 are bound to one another and formed into temporary particles. The obtained temporary particles fall vertically downward by the gravitational force and are accumulated.

Subsequently, the obtained temporary particles are subjected to a heating treatment. By this heating treatment, at least part of the binder 3 contained in the temporary particles is melted or vaporized (also including thermal decomposition). By doing this, the apparent particle diameter of the temporary particles is decreased, and granulated particles 1 are obtained. At this time, the apparent particle diameter of the temporary particles is decreased as the binder 3 is melted or vaporized by the heating treatment after the temporary particles having a shape close to a spherical shape are once formed, and therefore, the spherical shape is easily maintained even after the heating treatment. As a result, the granulated particles 1 which have high sphericity, and are composed of further densified temporary particles are obtained.

Further, the metal particles 2 become easy to move as the binder 3 is melted or vaporized, and for example, in the case where the temporary particles include spaces inside, the metal particles 2 become easy to move so as to bury the spaces. As a result, densification is achieved based on the optimization of the arrangement of the metal particles 2. Also from this viewpoint, the granulated particles 1 achieve densification more than the temporary particles.

The thus obtained granulated particles 1 have a high flow rate and also have a high bulk density ratio. That is, by increasing the sphericity of the granulated particles 1 while keeping the content of the binder 3 low, both improvement of the flow rate and improvement of the bulk density, which were difficult in the related art, are achieved. As a result, the granulated particles 1 capable of producing a sintered body having favorable surface roughness and dimensional accuracy, and also having high mechanical strength are obtained.

The heating treatment may be any treatment as long as it is a heating treatment under such conditions that at least part of the binder 3 contained in the temporary particles is moderately melted or vaporized. Specific examples thereof include heating in a heating furnace, flame irradiation, and laser irradiation.

Among these, heating in a heating furnace is preferably used. According to this method, a large number of temporary particles can be more uniformly heated. Therefore, the degree of heating is easily made uniform among the temporary particles. As a result, the shape such as sphericity and densification are easily made uniform in favorable states also among the granulated particles 1 obtained as a result of heating, and thus, both a relatively high flow rate and a relatively high bulk density ratio of the powder for energy beam sintering can be more reliably achieved.

The heating temperature varies depending on the composition of the binder 3 or the like, but is preferably about 200° C. or higher and 800° C. or lower, more preferably about 250° C. or higher and 700° C. or lower, further more preferably about 300° C. or higher and 600° C. or lower. By performing heating at such a temperature, although depending on the composition of the binder 3 or the like, the volume of the binder 3 can be moderately decreased by melting, vaporization, or the like without vaporizing the entire binder 3. That is, while preventing the granulated particles 1 from easily collapsing due to an excessive decrease in the binder 3, densification of the granulated particles 1 can be achieved. As a result, the flow rate and the bulk density ratio in the granulated particles 1 can be moderately enhanced.

The heating time is set according to the heating temperature, however, as the duration of the heating time, it is preferably about 5 minutes or more and 300 minutes or less, more preferably about 10 minutes or more and 180 minutes or less, furthermore preferably about 30 minutes or more and 120 minutes or less. By setting such a heating time, although depending on the heating temperature, the composition of the binder 3, or the like, the volume of the binder 3 can be decreased by melting, vaporization, or the like without vaporizing the entire binder 3. That is, while preventing the granulated particles 1 from easily collapsing due to an excessive decrease in the binder 3, densification of the granulated particles 1 can be achieved. As a result, the flow rate and the bulk density ratio in the granulated particles 1 can be moderately enhanced.

The heating atmosphere is not particularly limited, however, for example, an oxidizing atmosphere such as air or oxygen, an inert atmosphere such as nitrogen or argon, a reducing atmosphere such as hydrogen, or the like is used. Among these, in the case where oxidation of the metal particles 2 or the like is considered, an inert atmosphere or a reducing atmosphere is preferably used, and in the case where safety, hydrogen embrittlement, and the like are considered, an inert atmosphere is preferably used.

As described above, the granulated particles 1 are produced.

By performing the heating treatment, the granulated particles 1 further include a heated material of the binder 3. The heated material of the binder 3 refers to a molten material, a thermally denatured material, or the like of the binder 3. Such a heated material has a smaller volume than the binder 3 before heating. Therefore, by including the heated material, further densification of the granulated particles 1 is achieved. As a result, the powder for energy beam sintering capable of producing a sintered body of higher quality in terms of surface roughness, dimensional accuracy, and mechanical strength is obtained.

The method for producing the granulated particles 1 is not limited to the above-mentioned spray drying method, and may be, for example, any of various granulation methods such as a tumbling granulation method, a fluidized bed granulation method, and a tumbling fluidized bed granulation method. However, according to the spray drying method, temporary particles having high sphericity are obtained, and therefore, also as the granulated particles 1 to be obtained in the end, particles having a favorable flow rate and a favorable bulk density ratio are obtained.

Further, the powder for energy beam sintering may be a mixed powder obtained by adding an arbitrary powder to the granulated particles 1 produced as described above. The arbitrary powder may be any powder as long as it does not inhibit the sintering of the metal particles 2.

### Device for Producing Sintered Body

Next, as one example of a device for producing a sintered body using the above-mentioned powder for energy beam sintering, a laser sintering device will be described.

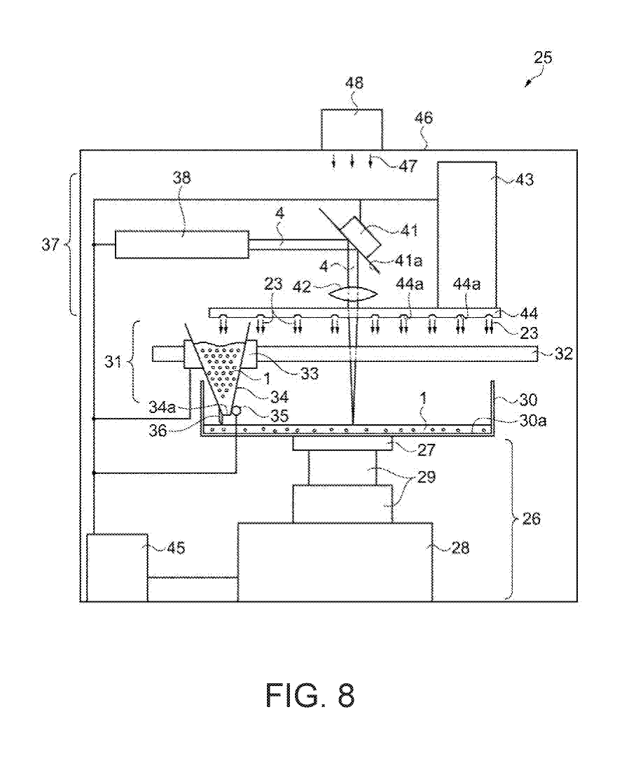

FIG. 8 is a schematic view showing a structure of a laser sintering device for producing a sintered body using the powder for energy beam sintering. As shown in FIG. 8, a laser sintering device 25 includes an XYZ stage 26. The XYZ stage 26 is a device which moves a table 27 in three axial directions orthogonal to one another. Specifically, the XYZ stage 26 includes an XY stage 28 and a lifting device 29. The XY stage 28 moves the table 27 in the horizontal direction. Further, the lifting device 29 is provided on the XY stage 28 and raises and lowers the table 27. The XY stage 28 includes a biaxial linear motion mechanism, and the lifting device 29 includes a uniaxial linear motion mechanism. According to this, the XYZ stage 26 can move the table 27 in the three axial directions orthogonal to one another.

On the table 27, a vessel 30 in a bottomed rectangular cylindrical shape is provided, and in the vessel 30, the powder for energy beam sintering is spread out. On the upper side of the vessel 30 in the drawing, a powder supply device 31 which supplies the powder for energy beam sintering into the vessel 30 is provided. The powder supply device 31 includes a rail 32 extending right and left in the drawing. Then, a moving stage 33 which moves along the rail 32 is provided. In the moving stage 33, a hopper 34 which stores the powder for energy beam sintering is provided. The hopper 34 has a triangular prism shape in an external appearance, and is provided with a discharge port 34a on a side facing a bottom 30a of the vessel 30.

The discharge port 34a is provided with a solenoid valve 35, and the solenoid valve 35 opens and closes the discharge port 34a. When the solenoid valve 35 opens the discharge port 34a, the powder for energy beam sintering flows from the discharge port 34a to the bottom 30a of the vessel 30. To the discharge port 34a, a leveling plate 36 is attached. The leveling plate 36 is also called “squeegee”. The solenoid valve 35 opens the discharge port 34a, and the moving stage 33 moves the hopper 34 and the leveling plate 36. By doing this, the powder for energy beam sintering is supplied to the bottom 30a, and the leveling plate 36 can level the surface of the powder for energy beam sintering flat. A mechanism in which a cylindrical roller moves while rotating may be provided in place of the leveling plate 36. Then, by rotating the roller, the surface of the powder for energy beam sintering may be leveled flat. By the moving stage 33, the hopper 34, the leveling plate 36, and the like as described above, a powder layer forming unit of the laser sintering device 25 is constituted.

On the upper side of the powder supply device 31 in the drawing, a laser irradiation unit 37 is provided. The laser irradiation unit 37 includes a laser light source 38. The laser light source 38 may be any as long as it can emit a laser 4 having a light intensity capable of sintering the metal particles 2, and a laser light source such as a carbon dioxide laser, an argon laser, or a YAG (yttrium aluminum garnet) laser can be used. The laser is a kind of energy beam, but may be replaced with another energy beam such as an electron beam or an ion beam.

The laser 4 emitted from the laser light source 38 is incident on a scanner 41. The scanner 41 includes a mirror 41a, and the scanner 41 rocks the mirror 41a. The laser 4 incident on the scanner 41 is reflected by the mirror 41a. At this time, the mirror 41a is rocked, and thus, the laser 4 is scanned by the scanner 41.

The laser 4 reflected by the mirror 41a is incident on a condensing lens 42. The condensing lens 42 is a cylindrical lens, and condenses the laser 4 to be scanned on the surface of the powder for energy beam sintering. The condensing lens 42 may be a single lens or a combination lens.

On the right side of the laser irradiation unit 37 in the drawing, a hot air blower 43 is provided. The hot air blower 43 includes a heater and heats a gas. The hot air blower 43 also includes a motor and an impeller, and the motor rotates the impeller to send the air. The hot air blower 43 includes an air blowing tube 44 on the side of the vessel 30. The air blowing tube 44 is provided with blowout ports 44a at equal intervals. The hot air blower 43 sends a hot air 23 to the air blowing tube 44. Then, the hot air 23 is sent toward the powder for energy beam sintering from the blowout ports 44a of the air blowing tube 44.

The laser sintering device 25 includes a controller 45. The controller 45 is electrically or optically connected to the XYZ stage 26, the moving stage 33, the solenoid valve 35, the laser light source 38, and the hot air blower 43. The controller 45 controls each device and forms a sintered body from the powder for energy beam sintering.

The laser sintering device 25 includes a chamber 46, and in the chamber 46, the XYZ stage 26, the vessel 30, the powder supply device 31, the laser irradiation unit 37, and the hot air blower 43 are disposed. On the chamber 46, an inert gas supply section 48 which supplies an inert gas 47 is provided. The chamber 46 is filled with the inert gas 47 inside. The type of the inert gas 47 is not particularly limited, however, in this embodiment, for example, argon gas is used as the inert gas 47. That is, the hot air 23 to be sent from the hot air blower 43 is composed of heated argon gas. Further, nitrogen gas may be used as the inert gas 47. According to this, the metal particles 2 can be prevented from oxidizing.

### Method for Producing Sintered Body

Next, an embodiment of a method for producing a sintered body according to the invention will be described.

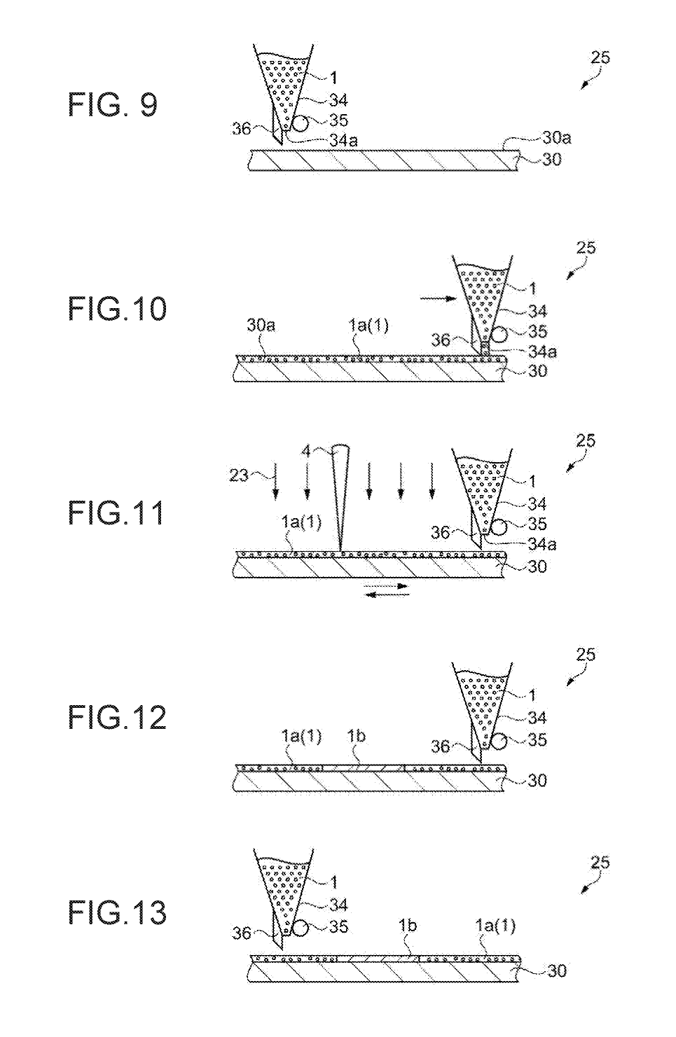

FIGS. 9 to 18 are each a schematic view for illustrating a method for forming a structure using the powder for energy beam sintering (an embodiment of the method for producing a sintered body according to the invention). Hereinafter, with reference to FIGS. 9 to 18, the method for forming a structure will be described. In this method, the laser sintering device 25 described above is used.

The method for producing a sintered body according to this embodiment includes a step of forming a powder layer 1a containing the powder for energy beam sintering, and a step of sintering metal particles 2 by irradiating the powder layer la with a laser 4 (energy beam). According to this method, a structure 49 (sintered body) of high quality can be efficiently produced.

Hereinafter, the respective steps will be sequentially described.

First, as shown in FIG. 9, the powder for energy beam sintering containing the granulated particles 1 is placed in the hopper 34 of the laser sintering apparatus 25. At this time, the solenoid valve 35 is closed to close the discharge port 34a. By doing this, the powder for energy beam sintering is held in the hopper 34. Then, the distance between the bottom 30a of the vessel 30 and the leveling plate 36 is set equal to the average particle diameter of the powder for energy beam sintering. Subsequently, as shown in FIG. 10, the solenoid valve 35 is opened to open the discharge port 34a. By doing this, the powder for energy beam sintering is supplied to the bottom 30a of the vessel 30 from the discharge port 34a. The moving stage 33 moves the hopper 34 and the leveling plate 36 while opening the discharge port 34a. By doing this, the powder for energy beam sintering is supplied to the bottom 30a. Further, the powder for energy beam sintering is spread out on the bottom 30a of the vessel 30 sequentially, and also the surface of the powder for energy beam sintering is leveled. By doing this, a powder layer 1a which is the first layer of the powder for energy beam sintering is formed. That is, by the powder layer forming unit constituted by the moving stage 33, the hopper 34, the leveling plate 36, and the like, the first layer of the powder layer 1a is formed. The thickness of the first layer of the powder layer 1a may be different from the average particle diameter of the powder for energy beam sintering, but is preferably set equal to the size of the average particle diameter. By doing this, in the first layer of the powder layer 1a, the granulated particles 1 are spread out such that the particles do not overlap with one another in the thickness direction. Subsequently, by closing the solenoid valve 35 to close the discharge port 34a, the powder for energy beam sintering is made not to flow out from the discharge port 34a.

Subsequently, as shown in FIG. 11, the hot air 23 is made to flow to the first layer of the powder layer 1a. By doing this, the first layer of the powder layer 1a is heated. The temperature of the heated first layer of the powder layer 1a is lower than the temperature at which the metal particles 2 are sintered. Subsequently, the laser 4 is irradiated such that the light is condensed on the first layer of the powder layer 1a. The laser 4 is scanned by the scanner 41, and also the first layer of the powder layer 1a is moved in the horizontal direction by the XY stage 28. By doing this, a given pattern is drawn on the first layer of the powder layer 1a.

The powder for energy beam sintering irradiated with the laser 4 is sintered at a temperature at which the powder for energy beam sintering is not melted. If the metal is heated until it is melted, the melted metal flows in the direction where the gravitational force or surface tension acts. Therefore, the metal is not heated until it is melted, but is heated up to a temperature at which the metal is sintered, whereby a structure (sintered body) of the metal can be accurately formed into a shape as it is drawn.

As a result, as shown in FIG. 12, a sintered layer 1b in which the metal particles 2 are sintered is formed in a region of the first layer of the powder layer 1a irradiated with the laser 4. At this time, the binder contained in the granulated particles 1 is vaporized. Thereafter, by the lifting device 29, the vessel 30 is lowered. Then, the distance between the sintered layer 1b and the leveling plate 36 is set substantially equal to the average particle diameter of the powder for energy beam sintering.

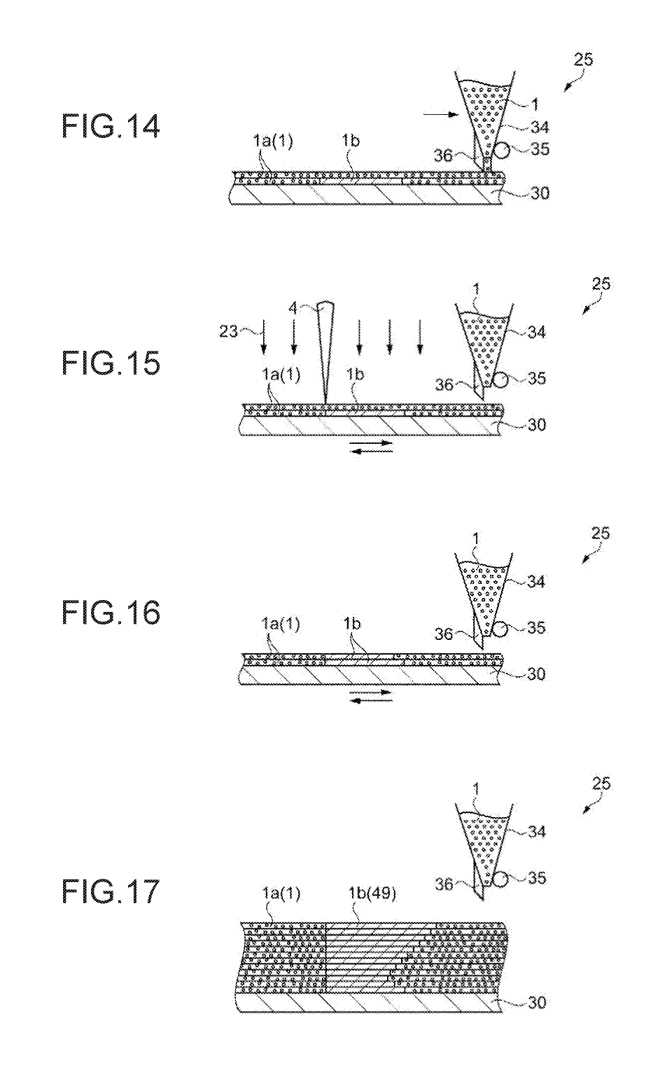

Subsequently, as shown in FIG. 13, by the moving stage 33, the hopper 34 and the leveling plate 36 are moved to the left side in the drawing. When the amount of the powder for energy beam sintering in the hopper 34 becomes small, the powder for energy beam sintering is replenished at this time. Then, as shown in FIG. 14, the solenoid valve 35 is opened to open the discharge port 34a. By doing this, the powder for energy beam sintering is supplied from the discharge port 34a onto the first layer of the powder layer 1a and the sintered layer 1b so as to overlap therewith. By the moving stage 33, the hopper 34 and the leveling plate 36 are moved while opening the discharge port 34a. By doing this, the powder for energy beam sintering is supplied to the bottom 30a and is spread out on the bottom 30a of the vessel 30 sequentially, and also the surface of the powder for energy beam sintering is leveled. By doing this, a powder layer 1a which is the second layer of the powder for energy beam sintering is formed on the first layer of the powder layer 1a and the sintered layer 1b so as to overlap therewith. Also at this time, the thickness of the second layer of the powder layer 1a may be different from the average particle diameter of the powder for energy beam sintering, but is preferably set equal to the size of the average particle diameter. By doing this, in the second layer of the powder layer 1a, the powder for energy beam sintering is spread out such that the granulated particles do not overlap with one another in the thickness direction. Subsequently, by closing the solenoid valve 35 to close the discharge port 34a, the powder for energy beam sintering is made not to flow out from the discharge port 34a.

Subsequently, as shown in FIG. 15, the hot air 23 is made to flow to the second layer of the powder layer 1a. By doing this, the second layer of the powder layer 1a is heated. Subsequently, the laser 4 is irradiated such that the light is condensed on the second layer of the powder layer 1a. The laser 4 is scanned by the scanner 41, and also the second layer of the powder layer 1a is moved in the horizontal direction by the XY stage 28. By doing this, a given pattern is drawn on the second layer of the powder layer 1a. As a result, as shown in FIG. 16, a sintered layer 1b in which the metal particles 2 are sintered is formed in a region of the second layer of the powder layer 1a irradiated with the laser 4. The sintered layer 1b is formed so as to be connected to the sintered layer 1b located below. Thereafter, by the lifting device 29, the vessel 30 is lowered. Then, the distance between the sintered layer 1b and the leveling plate 36 is set equal to the size of the average particle diameter of the powder for energy beam sintering. Also at this time, the distance between the sintered layer 1b and the leveling plate 36 may be different from the average particle diameter of the powder for energy beam sintering.

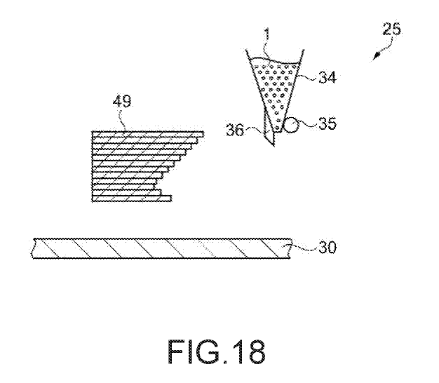

Thereafter, the step of forming the powder layer 1a so as to overlap with the sintered layer 1b formed by drawing and the step of emitting the laser 4 to the powder layer 1a are alternately repeated. As a result, as shown in FIG. 17, in the vessel 30, a structure 49 (sintered body) in which a large number of sintered layers 1b sintered in a given pattern are stacked is formed. Then, as shown in FIG. 18, the structure 49 is taken out from the vessel 30, and the powder for energy beam sintering adhered to the structure 49 is removed, whereby the production of the structure 49 is completed.

The structure 49 produced using the above-mentioned production method can be used for various purposes. For example, it can be used as a metal piece to be attached to the teeth for an orthodontic treatment in humans. This metal piece is designed to fit the shape of the teeth to which the metal piece is to be attached, and therefore, there are many types of parts. Also in this case, the structure 49 can be produced to fit a required shape.

Further, in addition to this, the structure 49 can be applied to all sorts of constituent parts including: parts for transportation machinery such as parts for automobiles, parts for railcars, parts for ships, and parts for airplanes; parts for electronic devices such as parts for personal computers and parts for mobile phone terminals; and parts for machines such as machine tools and semiconductor production apparatuses.

While the invention has been described based on the preferred embodiments above, the invention is not limited thereto.

For example, in the method for producing a powder for energy beam sintering, an arbitrary step can be added as needed.

Further, in the powder for energy beam sintering according to the invention, an arbitrary element may be added as needed.

The powder for energy beam sintering according to the invention is not used exclusively in the method for producing a sintered body according to the embodiment described above, but may be used in any method.

### EXAMPLES

Next, specific examples of the invention will be described.

### 1. Production of Powder for Energy Beam Sintering

### Example 1

(1) First, as a metal powder, a stainless steel powder (SUS630, manufactured by Epson Atmix Corporation) having an average particle diameter of 7 μm produced by a water atomization method was prepared.

(2) On the other hand, as a binder, polyvinyl alcohol (PVA-17, manufactured by Kuraray Co., Ltd.) was prepared. The melting point of polyvinyl alcohol was 200° C.

Then, as a solvent, ion exchanged water was prepared, and the above-mentioned binder component was added thereto, and thereafter, the resulting mixture was cooled to room temperature, whereby a binder solution was prepared. The composition of the binder, the mass ratio of the binder to the metal powder, etc. are as shown in Table 1.

(3) Subsequently, the metal powder and the binder solution were mixed, whereby a slurry was prepared. The ratio of the metal powder in the slurry was set to 70 mass %.

(4) Subsequently, in a spray drying device, the slurry was placed and granulated, whereby temporary particles having an average particle diameter of 60 μm were obtained.

(5) Subsequently, the obtained temporary particles were placed in a heating furnace, and a heating treatment was performed. By doing this, a powder for energy beam sintering was obtained. The heating conditions are as shown in Table 1. The obtained powder for energy beam sintering exhibited a gray color.

When comparing the powder for energy beam sintering after the heating treatment with the powder before the heating treatment (temporary particles), it was confirmed that part of the binder was converted into a heated material in the powder for energy beam sintering after the heating treatment.

### Examples 2 to 15

Powders for energy beam sintering were obtained in the same manner as in Example 1 except that the heating conditions in the heating treatment were changed as shown in Table 1, respectively. The average particle diameter of the stainless steel powder was 5 μm or more and 10 μm or less, and the average particle diameter of each of the powders for energy beam sintering was 3 times or more and 10 times or less the average particle diameter of the stainless steel powder.

### Comparative Example 1

A granulated powder composed of temporary particles was obtained in the same manner as in Example 1 except that the heating treatment was omitted.

### Comparative Examples 2 to 6

Powders for energy beam sintering were obtained in the same manner as in Example 1 except that the heating conditions in the heating treatment were changed as shown in Table 1, respectively.

### 2. Evaluation of Powder for Energy Beam Sintering

### 2.1. Measurement of Flow Rate

With respect to the powders for energy beam sintering obtained in the respective Examples and Comparative Examples and the granulated powder obtained in Comparative Example 1, the flow rate was measured by the test method for flow rate of metal powders specified in JIS Z 2502:2012.

Subsequently, the powder for energy beam sintering or the granulated powder after measuring the flow rate was placed in a box made of stainless steel, and vibration was applied thereto for 1 minute.

Subsequently, the flow rate of the powder after application of vibration was measured again, and the ratio of change from the flow rate before application of vibration was calculated.

The measurement results and calculation results are shown in Table 1.

### 2.2. Measurement of Bulk Density and Calculation of Ratio of Bulk Density to True Density

With respect to the powders for energy beam sintering obtained in the respective Examples and Comparative Examples and the granulated powder obtained in Comparative Example 1, the bulk density (apparent density) was measured by the test method for apparent density of metal powders specified in JIS Z 2504:2012.

Further, with respect to the measured bulk density, the ratio of the bulk density to the true density of the metal powder was calculated. The true density of SUS630 was determined to be 7.93 g/cm³.

The measurement results and calculation results are shown in Table 1.

### 3. Evaluation of Sintered Body

Each of the powders for energy beam sintering obtained in the respective Examples and Comparative Examples and the granulated powder obtained in Comparative Example 1 was placed in the laser sintering device.

Subsequently, the step of spreading out the powder for energy beam sintering or the granulated powder in a layer and the step of laser sintering are alternately repeated, whereby a sintered body having a cylindrical shape was obtained.

### 3.1. Evaluation of Surface Roughness

Then, the obtained sintered body was visually observed, and the degree of metallic luster was evaluated. This evaluation was performed according to the following evaluation criteria.
Evaluation Criteria for Surface Roughness
A: The degree of metallic luster is particularly high.
B: The degree of metallic luster is somewhat high.
C: The degree of metallic luster is somewhat low.
D: The degree of metallic luster is particularly low.

The evaluation results are shown in Table 1.

### 3.2. Evaluation of Mechanical Strength

A load was applied to the obtained sintered body, and the maximum load when the sintered body was fractured (fracture load) was compared. Specifically, the fracture load of the sintered body produced using the granulated powder obtained in Comparative Example 1 was assumed to be 1, and the relative value of the fracture load of each of the sintered bodies produced using the powders for energy beam sintering obtained in the respective Examples and Comparative Examples was calculated.

The calculation results are shown in Table 1.

TABLE 1

| | | | | | | | | Evaluation results of powder | |
|---|---|---|---|---|---|---|---|---|---|
| | | | | | | | | for energy beam sintering | |
| | Production conditions for powder for energy beam sintering | | | | | | | Flow rate | |
| | | | | | | | Average | Before | Ratio of change |
| | Metal | | | Heating treatment | | | particle | application of | after application |
| | powder | Binder | | temperature | time | atmosphere | diameter | vibration | of vibration |
| | composition | composition | mass % | ° C. | min | — | μm | sec/50 g | % |
| Comp. | SUS630 | PVA | 0.70 | — | — | — | 60 | 23.04 | −1 |
| Ex. 1 | | | | | | | | | |
| Comp. | SUS630 | PVA | 0.70 | 100 | 60 | air | 51 | 23.16 | −1 |
| Ex. 2 | | | | | | | | | |
| Ex. 1 | SUS630 | PVA | 0.70 | 250 | 60 | air | 52 | 23.22 | −3 |
| Ex. 2 | SUS630 | PVA | 0.70 | 300 | 60 | air | 49 | 23.66 | −3 |
| Ex. 3 | SUS630 | PVA | 0.70 | 400 | 60 | air | 51 | 23.16 | −3 |
| Ex. 4 | SUS630 | PVA | 0.70 | 500 | 60 | air | 48 | 23.23 | −5 |
| Comp. | SUS630 | PVA | 0.70 | 600 | 60 | air | 50 | 28.40 | −10 |
| Ex. 3 | | | | | | | | | |
| Comp. | SUS630 | PVA | 0.70 | 700 | 60 | air | 53 | 29.99 | −25 |
| Ex. 4 | | | | | | | | | |
| Ex. 5 | SUS630 | PVA | 0.70 | 250 | 60 | nitrogen | 54 | 23.22 | −1 |
| Ex. 6 | SUS630 | PVA | 0.70 | 300 | 60 | nitrogen | 50 | 23.53 | −1 |
| Ex. 7 | SUS630 | PVA | 0.70 | 400 | 60 | nitrogen | 48 | 21.99 | −1 |
| Ex. 8 | SUS630 | PVA | 0.70 | 500 | 60 | nitrogen | 49 | 21.33 | −1 |
| Ex. 9 | SUS630 | PVA | 0.70 | 600 | 60 | nitrogen | 51 | 21.33 | −2 |
| Comp. | SUS630 | PVA | 0.70 | 700 | 60 | nitrogen | 53 | 28.66 | −23 |
| Ex. 5 | | | | | | | | | |
| Ex. 10 | SUS630 | PVA | 0.50 | 550 | 30 | nitrogen | 48 | 21.66 | −1 |
| Ex. 11 | SUS630 | PVA | 0.60 | 450 | 90 | nitrogen | 50 | 21.66 | −1 |
| Ex. 12 | SUS630 | PVA | 0.80 | 350 | 120 | nitrogen | 52 | 21.66 | −1 |
| Ex. 13 | SUS630 | PVP | 0.70 | 400 | 60 | air | 50 | 24.66 | −3 |
| Comp. | SUS630 | PVP | 0.70 | 500 | 60 | air | 55 | 28.53 | −10 |
| Ex. 6 | | | | | | | | | |
| Ex. 14 | SUS630 | PVP | 0.70 | 500 | 60 | nitrogen | 56 | 25.33 | −2 |
| Ex. 15 | SUS630 | PVA | 0.10 | 400 | 60 | nitrogen | 45 | 19.40 | −2 |

| | Evaluation results | | | | |
|---|---|---|---|---|---|
| | of powder for energy | | | Evaluation results of sintered | |
| | beam sintering | | | body | |
| | Bulk density | | | Surface | Mechanical |
| | Measured | | | roughness of | strength of |
| | value | Ratio | Color | sintered body | sintered body |
| | g/cm³ | % | — | — | (relative value) |
| Comp. | 2.37 | 29.89 | gray | D | 1 |
| Ex. 1 | | | | | |
| Comp. | 2.38 | 30.01 | gray | C | 1.03 |
| Ex. 2 | | | | | |
| Ex. 1 | 2.53 | 31.90 | gray | B | 1.25 |
| Ex. 2 | 2.58 | 32.53 | brown | B | 1.36 |
| Ex. 3 | 2.57 | 32.41 | brown | B | 1.37 |
| Ex. 4 | 2.57 | 32.41 | black | B | 1.39 |
| Comp. | 2.57 | 32.41 | brown | C | 1.05 |
| Ex. 3 | | | | | |
| Comp. | 2.35 | 29.63 | black | D | 0.65 |
| Ex. 4 | | | | | |
| Ex. 5 | 2.42 | 30.52 | gray | B | 1.42 |
| Ex. 6 | 2.42 | 30.52 | gray | B | 1.45 |
| Ex. 7 | 2.53 | 31.90 | gray | A | 1.54 |
| Ex. 8 | 2.58 | 32.53 | gray | A | 1.63 |
| Ex. 9 | 2.58 | 32.53 | gray | A | 1.59 |
| Comp. | 2.37 | 29.89 | gray | D | 0.68 |
| Ex. 5 | | | | | |
| Ex. 10 | 2.61 | 32.91 | gray | A | 1.61 |
| Ex. 11 | 2.64 | 33.29 | gray | A | 1.62 |
| Ex. 12 | 2.67 | 33.67 | gray | A | 1.56 |
| Ex. 13 | 2.53 | 31.90 | brown | B | 1.40 |
| Comp. | 2.53 | 31.90 | black | C | 1.12 |
| Ex. 6 | | | | | |
| Ex. 14 | 2.55 | 32.16 | gray | B | 1.43 |
| Ex. 15 | 2.78 | 35.06 | gray | A | 1.51 |

As apparent from Table 1, it was confirmed that the sintered bodies produced using the powders for energy beam sintering obtained in the respective Examples are of high quality. It was also confirmed that depending on the heating atmosphere, the metal powder is discolored and the powder for energy beam sintering exhibits a brown or black color.

On the other hand, although not shown in Table 1, when evaluation was performed in the same manner as described above using a Co—Cr—Mo-based alloy (ASTM F75 alloy) powder and an Ni-based alloy (Inconel 600) powder in place of the stainless steel powder, it was confirmed that a sintered body produced using a powder for energy beam sintering corresponding to Example is of high quality as expected.

The entire disclosure of Japanese Patent Application No. 2016-233056 filed on Nov. 30, 2016 is expressly incorporated by reference herein.

What is claimed is:

1. A powder for energy beam sintering, comprising:
a plurality of metal particles; and
a binder which binds the metal particles to one another, wherein
the ratio of the bulk density to the true density of the metal particles is 30.5% or more and 45% or less, and
the flow rate is 15 sec/50 g or more and 28 sec/50 g or less.

2. The powder for energy beam sintering according to claim 1, wherein the main component of the metal particles is any of iron, nickel, and cobalt.

3. The powder for energy beam sintering according to claim 1, wherein the binder contains polyvinyl alcohol or polyvinylpyrrolidone.

4. The powder for energy beam sintering according to claim 1, wherein the average particle diameter of the metal particles is 2 μm or more and 20 μm or less.

5. The powder for energy beam sintering according to claim 1, further comprising a heated material of the binder.

6. A method for producing a powder for energy beam sintering, comprising:
obtaining temporary particles by binding metal particles to one another using a binder solution containing a binder; and
heating the temporary particles.

7. A method for producing a sintered body, comprising:
forming a powder layer containing the powder for energy beam sintering according to claim 1; and
sintering the metal particles by irradiating the powder layer with an energy beam.

8. A method for producing a sintered body, comprising:
forming a powder layer containing the powder for energy beam sintering according to claim 2; and
sintering the metal particles by irradiating the powder layer with an energy beam.

9. A method for producing a sintered body, comprising:
forming a powder layer containing the powder for energy beam sintering according to claim 3; and
sintering the metal particles by irradiating the powder layer with an energy beam.

10. A method for producing a sintered body, comprising:
forming a powder layer containing the powder for energy beam sintering according to claim 4; and
sintering the metal particles by irradiating the powder layer with an energy beam.

11. A method for producing a sintered body, comprising:
forming a powder layer containing the powder for energy beam sintering according to claim 5; and
sintering the metal particles by irradiating the powder layer with an energy beam.
